(19) United States
(12) Patent Application Publication
(10) Pub. No.: US 2008/0112700 A1
(43) Pub. Date: May 15, 2008

(54) IMAGING DEVICE WITH PROJECTED VIEWFINDER

(76) Inventors: Eral D. Foxenland, Malmo (SE); Jenny Fredriksson, Lund (SE); Tom Pelzer, Kerkrade (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/558,945

(22) Filed: Nov. 13, 2006

(51) Int. Cl. G03B 13/02; H04N 5/222

(52) U.S. Cl. 396/148; 396/431; 348/333.01; 348/E05.022

(57) ABSTRACT

An imaging device includes a camera for at least one of taking a photograph or filming a video. The imaging device also includes a projection viewfinder assembly that projects a viewfinder to visually indicate a field of view of the camera.

### TECHNICAL FIELD OF THE INVENTION

The present invention relates generally to imaging devices, such as cameras. More particularly, the present invention relates to an imaging device having a projected viewfinder and a method of imaging.

### DESCRIPTION OF THE RELATED ART

Imaging devices, such as still cameras and/or video cameras, have a viewfinder that allows the user to determine the field of view of the camera. Conventional film cameras typically have an optical viewfinder through which the user may view the scene being photographed. The optical viewfinder may be separated from the lens used to image the film or, in the case of a single lens reflex (SLR) camera, through the lens used to image the film.

With the advent of video cameras that record to magnetic tapes, digital still cameras, digital video recorders and digital cameras that have both still picture image taking capability and video taking capability, electronic viewfinders have become widely used. For instance, digital still and/or video cameras typically have a small electronic display (e.g., a liquid crystal display or LCD) that may be viewed by the user as an indication of the scene as observed by the camera. The scene on the electronic display may change as the user moves the camera or uses a zoom feature to “zoom-in” or “zoom-out.” Some digital cameras may also include a conventional optical viewfinder and some digital SLR cameras may only have an optical viewfinder.

Regardless of whether a camera has an optical viewfinder and/or an electronic viewfinder, the user must look at or through the camera to get an indication of the camera's view of the scene. Most of the time, cameras with electronic viewfinders are held in front of the user. While this allows the user to gauge the field of view of the camera, it also obscures the user's ability to independently observe the scene.

### SUMMARY

To reduce the reliance on optical and/or electronic viewfinders, there is a need in the art for a system and method for projecting a viewfinder so that the viewfinder is viewable along with the scene being imaged (e.g., photographed, filmed and/or scanned).

According to one aspect of the invention, an imaging device includes a camera for at least one of taking a photograph or filming a video; and a projection viewfinder assembly that projects a viewfinder to visually indicate a field of view of the camera.

According to an embodiment of the imaging device, the projection viewfinder assembly includes at least one laser and the projected viewfinder is defined by a laser beam generated by the laser.

According to an embodiment of the imaging device, the projection viewfinder assembly is configured to modify the projected viewfinder in response to a change in zoom of the camera so that the projected viewfinder maintains a relationship with the field of view of the camera as the zoom of the camera changes.

According to an embodiment of the imaging device, the projection viewfinder is projected adjacent the field of view of the camera so that the viewfinder is not imaged by the camera when taking a photograph or filming a video.

According to an embodiment of the imaging device, the projection viewfinder assembly is configured to turn off the projected viewfinder during the taking of a photograph or the filming of a video.

According to an embodiment of the imaging device, the projection viewfinder assembly is configured to change a color of at least a portion of the projected viewfinder to indicate a condition related to the camera.

According to an embodiment of the imaging device, the color is changed when filming a video.

According to an embodiment of the imaging device, the color is changed when the camera is ready to take a photograph or is ready to film a video.

According to an embodiment of the imaging device, one color indicates a still photography mode of the camera and another color indicates a video mode of the camera.

According to an embodiment of the imaging device, the projection viewfinder assembly also projects a graphic or text component.

According to an embodiment of the imaging device, the graphic or text component is projected in the field of view of the camera to form part of a photograph taken with the camera or a video filmed with the camera.

According to an embodiment of the imaging device, the projected viewfinder includes projected spots that have a relationship with corners of the field of view of the camera.

According to an embodiment of the imaging device, the projected viewfinder includes projected lines that have a relationship with edges of the field of view of the camera.

According to an embodiment of the imaging device, the projected viewfinder is viewable with the naked eye of a user of the imaging device.

According to an embodiment of the imaging device, the projected viewfinder is not viewable with the naked eye of an observer of the field of view of the camera.

According to an embodiment of the imaging device, the imaging device is configured to communicate in a communications network and includes a radio circuit over which a call is established.

According to another aspect of the invention, an imaging device includes a sensor for scanning a surface; and a projection viewfinder assembly that projects a viewfinder to visually indicate a peripheral boundary of a field of view of the sensor.

According to another aspect of the invention, a method of imaging a scene includes pointing a camera toward the scene; projecting a viewfinder that visually indicates a field of view of the camera; and imaging the scene with the camera.

According to an embodiment of the method, the imaging of the scene is one of taking a photograph or filming a video.

According to an embodiment, the method further includes modifying the projected viewfinder in response to a change in zoom of the camera so that the projected viewfinder maintains a relationship with the field of view of the camera as the zoom of the camera changes.

According to an embodiment, the method further includes changing a color of at least a portion of the projected viewfinder to indicate a condition related to the camera.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a side view of an exemplary imaging device in accordance with an embodiment of the present invention;

FIG. 2 is an end view of the imaging device of FIG. 1;

FIG. 3 is a perspective view of the imaging device of FIG. 1 while in use to project a viewfinder;

FIG. 4 is a schematic view of an exemplary embodiment of a projected viewfinder according to an embodiment of the invention;

FIG. 5 is a schematic view another exemplary embodiment of a projected viewfinder according to an embodiment of the invention;

FIG. 6 is a front view of an exemplary imaging and communications device in accordance with an embodiment of the present invention;

FIG. 7 is a rear view of the imaging and communications device of FIG. 6;

FIG. 8 is a schematic block diagram of the imaging and communications device of FIG. 6; and

FIG. 9 is a schematic diagram of a communications system in which the imaging and communications device of FIG. 6 may operate.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

In the present application, the invention is described primarily in the context of an imaging device. The imaging device may be configured to take still photographs, record video and/or scan a surface (e.g., optically scan a piece of paper). In most embodiments, the imaging device may be considered to be a camera. However, it will be appreciated that the invention is not intended to be limited to the context of a camera and may relate to any type of appropriate electronic equipment, examples of which include a scanner, a mobile telephone, a media player, a gaming device and a computer. Also, the interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

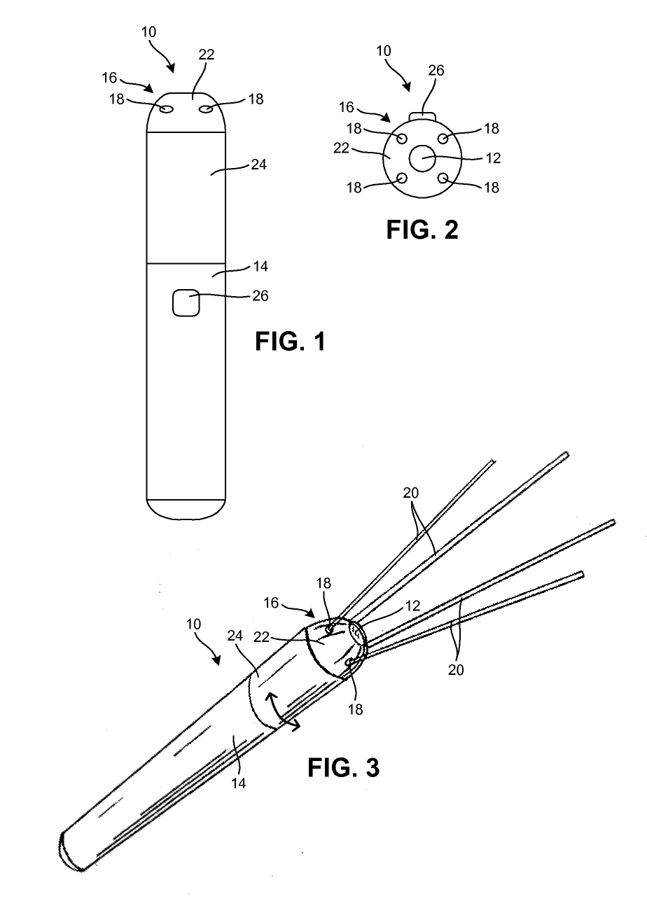

Referring to FIGS. 1 to 3, an imaging device 10 is shown. In the illustrated embodiment, the imaging device 10 includes a digital camera 12 capable of taking still images (e.g., taking photographs) and/or recording video content (e.g., filming a video and recording associated audio). The images and/or video may be stored by a memory (not shown) of the imaging device 10.

In the illustrated embodiment, the imaging device 10 has a generally cylindrical housing 14 with the final lens element of the camera 12 at one end of the imaging device 10. The imaging device 10 is not limited to a cylindrical arrangement and may take any other physical form.

While not illustrated, the imaging device 10 may include a display for functioning as a viewfinder and/or for displaying captured images and/or video. Other features may include a controller for controlling operation of the imaging device and managing imaging settings, an interface (e.g., an electrical connector such as a USB port and/or a wireless communicator such a Bluetooth interface) for exchanging data with another device, a flash or light to improve imaging in certain illumination conditions, and any other features that one may typically find in connection with a digital camera assembly. The camera 12 may have a set or variable focus. For variable focus cameras, the camera 12 may be focused using any appropriate auto-focusing technique or manual focusing technique.

The imaging device 10 includes a projection viewfinder assembly 16. In one embodiment, the projection viewfinder assembly 16 includes a plurality of lasers 18. Each laser 18 may generate a corresponding beam of light 20 or other radiation. In one embodiment, the wavelength of the light beams 20 may be visible to the human eye. In other embodiments, the wavelength of the light beams 20 may be invisible to the naked eye, but visible with the assistance of another device, such as contact lenses or a pair of glasses or goggles that allow the light beams 20 to be seen. In other embodiments, the wavelength of the light beams 20 may be detectable by a detector or a machine vision assembly. As will be appreciated, the lasers 18 may be replaced by other radiation generating devices, including one or more light bulbs, light emitting diodes (LEDs) (some may consider LEDs to be a form of laser), and so forth.

In one embodiment, the beams 20 may be generated using laser technology commonly found in laser pointers and/or laser levels. For instance, the lasers 18 may be a deep red laser diode that outputs a wavelength of about 650 nm to about 670 nm, a red-orange laser diode that outputs a wavelength of about 635 nm, or a yellow-orange laser diode that outputs a wavelength of about 594 nm. Other colors are possible. For instance, a 532 nm green laser (e.g., a diode pumped solid state or DPSS laser), a 473 nm blue laser (e.g., a blue DPSS laser), or a blue laser diode (e.g., a Blu-ray laser expected to be available in 2007 or 2008) may be employed. In embodiments described below, one or more of the beams 20 may be changed in color by providing two lasers for each beam and selectively turning on one of the lasers while the other of the lasers off.

The beams 20 may visually indicate the field of view of the camera 12 to the user. As will be appreciated, the field of view of the camera 12 increases as the distance from the camera 12 increases. Thus, the lasers 18 may be arranged so that the projected beams 20 are disposed an angle to the optical axis of the camera 12. The angle may be selected so that the beams 20 approximately follow the boundary of the field of view as distance from the camera 12 increases. In one embodiment, there are four lasers 18 arranged in a square or rectangle around the final lens of the camera 12 such that the lasers 18 generate corresponding laser beams 20 that project along corresponding corners of a square or rectangular field of view. For instance, in the illustrated embodiment, the lasers 18 are contained within a curved head 22 of the imaging device and the beams 20 are emitted from apertures in the head 22 that surround the camera 12.

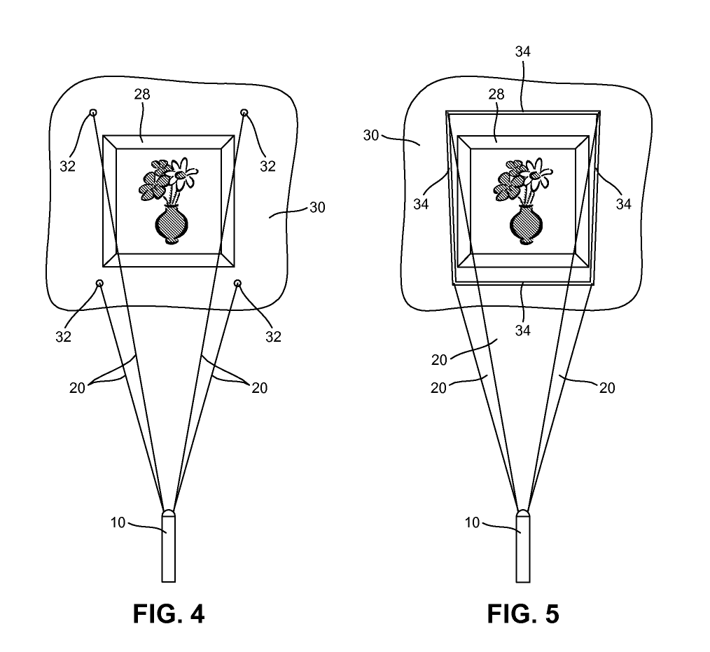

As will be further appreciated, the field of view of the camera 12 may change based on optical zoom and/or digital zoom settings that may be increased and decreased by user action. In one embodiment, the zoom of the illustrated imaging device 10 may be changed by rotating a portion of the cylindrical housing 14. For instance, a portion 24 of the housing 14 adjacent the head 22 may rotate with respect to the rest of the housing 14 as depicted by the arrow in FIG. 3. Rotation of the portion 24 may mechanically move optical elements of the camera 12 to change the optical zoom and/or result in a corresponding digital zoom operation. In addition, rotation of the portion 24 may change the direction of the beams 20 to remain commensurate with the field of view of the camera 12. For instance, rotation of the portion may mechanically move (e.g., pivot) the lasers 18 or mechanically move optics through which the beams 20 are directed. In other embodiments, user operable keys may be present to control optical zooming of the camera 12 (e.g., under the influence of motors) and/or digital zooming of the camera 12. In any of these embodiments, the beams 20 may be controlled mechanically and/or electronically to maintain a relationship to the field of view of the camera.

The camera 12 may be controlled to take a picture and/or start filming video or stop filming video by user interaction with a key 26. Other types of user input devices to control the camera 12 will be apparent to one of ordinary skill in the art. Additional keys or user input devices may be present to alter settings of the camera 12, change operational modes (e.g., switch between a still image mode and a video mode), and so forth.

FIGS. 4 and 5 illustrate the imaging device 10 in use to take a picture of a relatively flat surface. In the illustrated embodiment, the target of the photograph is a painting 28 that hangs on a wall 30. Of course, the imaging device 10 may be used to take pictures and/or video of other targets and the illustration of a painting hanging on a wall is merely representative of the operation of the projection viewfinder assembly 16.

In the representation of FIG. 4, four beams 20 are generated by the projection viewfinder assembly 16. Each beam 20 is incident on the wall 30 and illuminates a spot 32. The spots 32 may provide a visual indication to the user as to the field of view of the camera 12. In the illustrated example, the imaging device 10 is positioned in front of and slightly below the painting 28. The camera 12 is pointed toward the painting such that the imaging device 10 is disposed at a slight upward angle. In this arrangement, if it is assumed that the beams 20 are arranged to project in the form of a square, the upper spots may be spaced further apart from one another than the lower spots 32 since the distance from the imaging device 10 to the wall near the upper portion of the field of view of the camera 12 is larger than the distance from the imaging device 10 to the wall near the lower portion of the field of view of the camera 12. Changing the position and/or orientation of the imaging device 10 with respect to objects in the field of view of the camera 12 will result in similar spot 32 placement, depending on the geometrical relationships involved. Also, the shape of the field of view and corresponding spread of the beams 20 (e.g., angle of the beams 20 with respect to one another) will contribute to the size and shape of the pattern formed by the spots 32. For instance, the camera 12 may have a square field of view, a rectangular field of view, an oval field of view (e.g., as experienced with many fish-eye lenses), and the beams 20 may be arranged to provide a representation of where the boundaries of that field of view is located.

It is contemplated that the projection viewfinder assembly 16 may work best when the camera 12 is used to image objects or scenes (e.g., the target of the imaging) where the target includes or is surrounded by items that are about the same distance from the imaging device 10 as the target. In these situations, the visual feedback provided by the projection viewfinder assembly 16 may be a reliable representation of the field of view of the camera 12. It is likely that these situations will typically occur when the target is relatively close to the imaging device and/or a surface is present behind the target or is part of the target (e.g., a group of people standing in front of a wall). However, the projection viewfinder assembly 16 may have use in other situations. For instance, the incidence of one, two or three of the beams 20 on the target or an object near the target may be sufficient to provide the user with enough feedback to align the imaging device 10 with enough accuracy to take a satisfactory photograph. Also, even if one or more of the beams 20 become incident on objects that are at different distances than the target, the user may mentally integrate the corresponding spots 32 with the target to satisfactorily align the imaging device 10.

In one embodiment, the beams 20 may be directed so that the spots 32 fall slightly outside the field of view of the camera 12. In this embodiment, it is predicted that the spots 32 will not appear in a photograph or video taken with the camera 12. In addition or in the alternative, the lasers 18 used to generate the beams 20 may be turned off during operation of the camera 12 to take a photograph or video. After the photograph or video is taken the lasers 18 may be turned back on or kept off until user action is taken to turn the lasers 18 back on.

As indicated, beams of changing or multiple colors may be used. In one embodiment, one or more red beams 20 may be projected to generate red spots 32 while the user positions the imaging device 10 and the red beams 20 may change to green beams 20 to generate green spots 32 when the camera 12 is ready to take a picture (e.g., has completed an auto-focusing task, is sufficiently stationary, has adequate illumination, etc.). In embodiments where the imaging device 10 is configured to record video, one or more of the beams 20 may be red when the camera is stand-by mode and awaiting a user input to start filming and one or more of the beams 20 may change to green while filming is taking place. At the end of filming, the beams may change back to their original color. Also, one color may be used to indicate that the camera 12 is in a still photography mode and another color may be used to indicate that the camera 12 is in a video mode. In addition, the color of the beams, the number of beams and/or the on/off state of the beams (e.g., flashing of one or more beams) may be used to indicate any of the foregoing conditions or other conditions, such as a low battery condition, a low available memory condition, a poor illumination condition, and so forth.

The representation of FIG. 5 is similar to the representation of FIG. 4, except that the beams 20 have a shape so that when the beams are incident on a surface visible lines 34 are illuminated on the surface. Similar to the spots 32, the lines 34 may provide a visual indication to the user as to the field of view of the camera 12. In the illustrated example, one line 34 is projected above the field of view, one line 34 is projected below the field of view, one line 34 is projected to the left of the field of view and one line 34 is projected to the right of the field of view. Also, in the illustrated embodiment, the elongation of the beams 20 is such that the resulting lines 34 may connect to each other when projected on a relatively flat surface to form a continuous, two-dimensional boundary around the field of view. Other configurations may establish a partial visual boundary around the field of view, such as “L-shaped” illuminations at the corners of the field of view, “plus-shaped” (e.g., “+”) illuminations as the corners of the field of view, partial line segments, and so forth. Also, the beams 20 need not be linear and may be curved. The optics that may be used to generate a desired beam 20 pattern will be apparent to one of ordinary skill in the art and will not be described in detail.

In the representation of FIG. 5, the imaging assembly 10 is positioned in front of and slightly below the painting 28 so that the camera 12 is pointed toward the painting and the imaging device 10 is disposed at a slight upward angle. If it is assumed that the lines 34 are arranged to form a square or rectangle when the imaging device 10 is placed at a right angle to the wall 30, then, in the illustrated orientation of the imaging device 10, the left and right lines 34 may spread slightly from bottom to top and the top line 34 may be longer than the bottom line 34. The result is a trapezoid-shaped visual representation of the field of view of the camera 12. Changing the position and/or orientation of the imaging device 10 with respect to objects in the field of view of the camera 12 will result in similar line 34 placement, depending on the geometrical relationships involved. Also, the shape of the field of view and corresponding arrangement of the beams 20 will contribute to the size and shape of the pattern formed by the lines 34 that, in turn, provides a representation of where the boundary of the field of view is located.

The beams 20 in the foregoing embodiments are projected to become incident on a surface that is at (e.g., coincident with) or near the boundary of the field of view of the camera 12. In other embodiments, the beams 20 may be directed to become incident a surface inside the field of view of the camera and/or form a pattern (e.g., an arrangement of spots, a circle, a rectangle, cross-hairs, etc.) within the field of view of the camera 12.

In other embodiments, one or more of the lasers 18 may be configured to project words, characters and/or symbols. The projected information may provide the user with feedback regarding imaging settings, operational status of the imaging device 10, and so forth. In this manner, information such as battery life, number of remaining pictures or remaining recording time, camera mode (e.g., still picture versus video), etc., may be displayed to the user as part of the scene observed by the user. The projected data may be projected outside the field of view of the camera 12 to avoid imaging of the data. Alternatively, the projected data may be momentarily turned off during imaging. In another embodiment, projected data may be placed inside the field of view of the camera 12 with the intention of having the data imaged. For instance, the projected data may be the date on which the image is taken or may be a message such as “Happy Birthday.” Messages may be composed by the user and/or selected from a pre-stored menu of messages.

As indicated, the projection viewfinder assembly 16 may be combined with imaging devices that have a different arrangement than the imaging device 10 illustrated in FIGS. 1 through 5. For instance, the viewfinder assembly 16 may be added to any type of conventional film or digital still camera or any type of conventional analog or digital video camera, even if these cameras have an optical and/or electronic viewfinder.

Also, an imaging device that includes the viewfinder assembly 16 need not be a camera and/or may have other uses. For instance, the imaging device may be scanner for scanning bar codes, such as an inventory control scanner, point-of-sale scanner connected to a cash register, or similar device. As another example, the imaging device may be a scanner for scanning documents, such as printed sheets of paper or books. Such a document scanner may be handheld or form part of a larger apparatus. For instance, the user may hold the imaging device over the document and identify the area that will be scanned by observing the projected viewfinder. In embodiments where the imaging device is configured as a scanner, the camera 12 may be used as the scanning sensor or the camera 12 may be replaced by another kind of sensor.

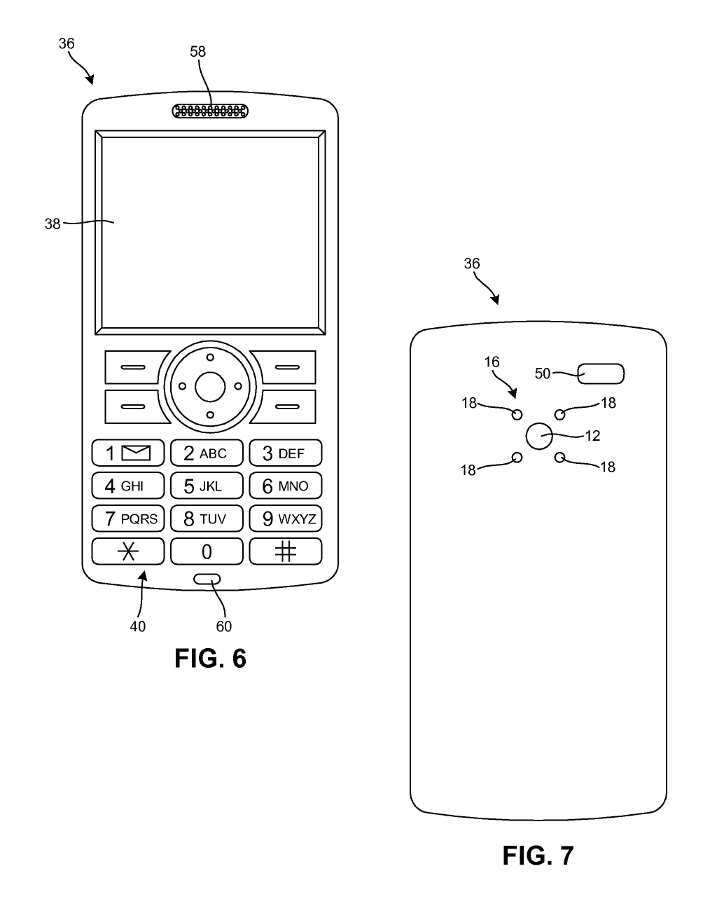

In another embodiment, the projection viewfinder assembly 16 may be added to an electronic device, such as a computer, gaming device, mobile telephone and so forth. For instance, with reference to FIGS. 6 through 9, an electronic device 36 that includes a camera 12 and a projection viewfinder assembly 16 is shown. The electronic device 36 of the illustrated embodiment is a mobile telephone and will be referred to as the mobile telephone 36. The mobile telephone 36 is shown as having a “brick” or “block” form factor housing, but it will be appreciated that other type housings, such as a clamshell housing or a slide-type housing, may be utilized.

As will be understood by those with ordinary skill in the art, the mobile telephone 36 may include a camera 12 for taking photographs and/or filming video. A display 38 may be used to displays information, menus, images, video and other graphics to the user, such as photographs, mobile television content and video associated with games. Also, the display 38 may serve as an electronic viewfinder for the camera 12. When the camera 12 is enabled, the electronic viewfinder function of the display 38 may be turned on and used together with the projection viewfinder assembly 16. Alternatively, the electronic viewfinder function of the display 38 may be turned off in favor of the projection viewfinder assembly 16. The use of the display 38 as an electronic viewfinder may be controlled by user action and/or logical operations carried out by the mobile telephone 36.

A keypad 40 provides for a variety of user input operations, including entering alphanumeric characters, navigating menus, selecting menu items, operating various mobile telephone functions, controlling operation of the camera 12, controlling operation of the projection viewfinder assembly 16, and so forth. For example, the keypad 40 may include alphanumeric keys, function keys, soft keys and a navigation input device. Other keys may include a volume key, an audio mute key, an on/off power key, etc. Keys or key-like functionality also may be embodied as a touch screen associated with the display 38.

The mobile telephone 36 includes call circuitry that enables the mobile telephone 36 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi, WiMax, etc. Another example includes a video enabled call that is established over a cellular or alternative network.

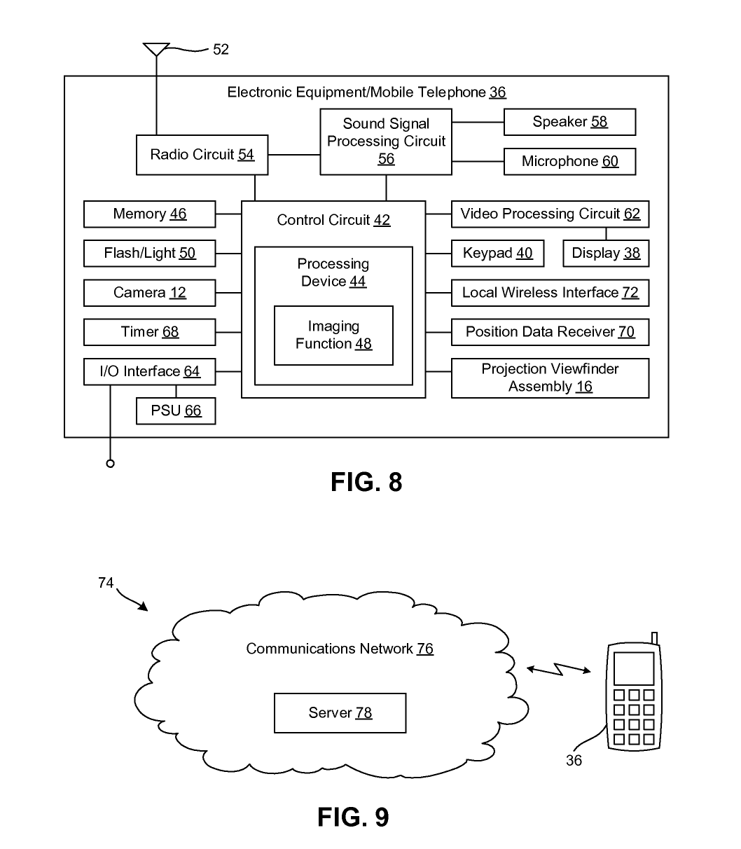

The mobile telephone 36 may be configured to transmit, receive and/or process data, such as text messages (e.g., colloquially referred to by some as “an SMS,” which stands for simple message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in a memory 46 (FIG. 8), executing applications to allow user interaction with data, displaying video and/or image content associated with the data, outputting audio sounds associated with the data and so forth.

FIG. 8 represents a functional block diagram of the mobile telephone 36. For the sake of brevity, generally conventional features of the mobile telephone 36 will not be described in great detail herein. The mobile telephone 36 includes a primary control circuit 42 that is configured to carry out overall control of the functions and operations of the mobile telephone 36. The control circuit 42 may include a processing device 44, such as a CPU, microcontroller or microprocessor. The processing device 44 executes code stored in a memory (not shown) within the control circuit 42 and/or in a separate memory, such as the memory 46, in order to carry out operation of the mobile telephone 36. The memory 46 may be, for example, one or more of a buffer, a flash memory, a hard drive, a removable media, a volatile memory, a non-volatile memory or other suitable device. The memory 46 may be used to store image files corresponding to photographs taken with the camera 12 and/or video files having a video component captured by the camera 12.

In addition, the processing device 44 may execute code that implements the various operational functions of the mobile telephone 36. One such function may be an imaging function 48 that controls operation of the camera 12 and/or the projection viewfinder assembly 16. It will be apparent to a person having ordinary skill in the art of computer programming, and specifically in application programming for mobile telephones or other electronic devices, how to program a mobile telephone 36 to operate and carry out logical functions associated with the mobile telephone 36. Accordingly, details as to specific programming code have been left out for the sake of brevity. Also, while the logical functions are executed by the processing device 44 in accordance with a preferred embodiment of the invention, such functionality could also be carried out via dedicated hardware, firmware, software, or combinations thereof, without departing from the scope of the invention.

The mobile telephone 36 may include an illumination device 50, such as a flash and/or a lamp, for improving photographs and/or video by providing a supplemental light source to the imaged scene. The illumination device 50 may be controlled in coordination with the camera 12 and/or the projection viewfinder assembly 16.

Continuing to refer to FIGS. 6 through 9, the mobile telephone 36 includes an antenna 52 coupled to a radio circuit 54. The radio circuit 54 includes a radio frequency transmitter and receiver for transmitting and receiving signals via the antenna 52 as is conventional. The radio circuit 54 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc., as well as advanced versions of these standards.

The mobile telephone 36 further includes a sound signal processing circuit 56 for processing audio signals transmitted by and received from the radio circuit 54. Coupled to the sound processing circuit 56 are a speaker 58 and a microphone 60 that enable a user to listen and speak via the mobile telephone 36 as is conventional. The microphone 60 may be used to capture sound for a sound component of video filmed using the camera 12. The radio circuit 54 and sound processing circuit 56 are each coupled to the control circuit 42 so as to carry out overall operation. Audio data may be passed from the control circuit 42 to the sound signal processing circuit 56 for playback to the user. The audio data may include, for example, audio data from an audio file stored by the memory 46 and retrieved by the control circuit 42, or received audio data such as in the form of streaming audio data from a mobile radio service. The sound processing circuit 56 may include any appropriate buffers, decoders, encoders, amplifiers and so forth.

The display 38 may be coupled to the control circuit 42 by a video processing circuit 62 that converts video data to a video signal used to drive the display 38. The video processing circuit 62 may include any appropriate buffers, decoders, video data processors and so forth. The video data may be generated by the control circuit 42, retrieved from a video file that is stored in the memory 46, derived from an incoming video data stream received by the radio circuit 54 or obtained by any other suitable method.

The mobile telephone 36 may further include one or more I/O interface(s) 64. The I/O interface(s) 64 may be in the form of typical mobile telephone I/O interfaces and may include one or more electrical connectors. As is typical, the I/O interface(s) 64 may be used to couple the mobile telephone 36 to a battery charger to charge a battery of a power supply unit (PSU) 66 within the mobile telephone 36. In addition, or in the alternative, the I/O interface(s) 64 may serve to connect the mobile telephone 36 to a headset assembly (e.g., a personal handsfree (PHF) device) that has a wired interface with the mobile telephone 36. Further, the I/O interface(s) 64 may serve to connect the mobile telephone 36 to a personal computer or other device via a data cable for the exchange of data. The mobile telephone 36 may receive operating power via the I/O interface(s) 64 when connected to a vehicle power adapter or an electricity outlet power adapter.

The mobile telephone 36 also may include a timer 68 for carrying out timing functions. Such functions may include timing the durations of calls, generating the content of time and date stamps, etc. The mobile telephone 36 also may include a position data receiver 70, such as a global positioning system (GPS) receiver, Galileo satellite system receiver or the like. The mobile telephone 36 also may include a local wireless interface 72, such as an infrared transceiver and/or an RF adaptor (e.g., a Bluetooth adapter), for establishing communication with an accessory, another mobile radio terminal, a computer or another device. For example, the local wireless interface 72 may operatively couple the mobile telephone 36 to a headset assembly (e.g., a PHF device) in an embodiment where the headset assembly has a corresponding wireless interface.

As shown in FIG. 9, the mobile telephone 36 may be configured to operate as part of a communications system 74. The communications system 74 may include a communications network 76 having a server 78 (or servers) for managing calls placed by and destined to the mobile telephone 36, transmitting data to the mobile telephone 36 and carrying out any other support functions. The server 78 communicates with the mobile telephone 36 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 76 may support the communications activity of multiple mobile telephones 36 and other types of end user devices. As will be appreciated, the server 78 may be configured as a typical computer system used to carry out server functions and may include a processor configured to execute software containing logical instructions that embody the functions of the server 78 and a memory to store such software.

Regardless of the imaging device in which the projection viewfinder assembly 16 is incorporated, the projection viewfinder assembly 16 may facilitate taking an image of scene. For instance, the user may accurately direct the imaging device to image the scene without placing the imaging device in front of his or her face to look at an optical or electronic viewfinder. Rather, the user may simply point the device and observe the illumination generated by the projection viewfinder assembly 16. Also, the user may change the zoom of the imaging device, interact with the imaging device and/or receive feedback regarding operational status from the imaging device while directly observing the field of view of the imaging device. In the illustrated examples, the projection viewfinder assembly 16 projects a viewfinder using lasers 18 that surround the final lens of a camera. It will be appreciated, that the projection apparatus may be located adjacent the lens (e.g., to one side of the lens) and/or may use a projection viewfinder generator other than lasers.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An imaging device, comprising:
a camera for at least one of taking a photograph or filming a video; and
a projection viewfinder assembly that projects a viewfinder to visually indicate a field of view of the camera.

2. The imaging device of claim 1, wherein the projection viewfinder assembly includes at least one laser and the projected viewfinder is defined by a laser beam generated by the laser.

3. The imaging device of claim 1, wherein the projection viewfinder assembly is configured to modify the projected viewfinder in response to a change in zoom of the camera so that the projected viewfinder maintains a relationship with the field of view of the camera as the zoom of the camera changes.

4. The imaging device of claim 1, wherein the projection viewfinder is projected adjacent the field of view of the camera so that the viewfinder is not imaged by the camera when taking a photograph or filming a video.

5. The imaging device of claim 1, wherein the projection viewfinder assembly is configured to turn off the projected viewfinder during the taking of a photograph or the filming of a video.

6. The imaging device of claim 1, wherein the projection viewfinder assembly is configured to change a color of at least a portion of the projected viewfinder to indicate a condition related to the camera.

7. The imaging device of claim 6, wherein the color is changed when filming a video.

8. The imaging device of claim 6, wherein the color is changed when the camera is ready to take a photograph or is ready to film a video.

9. The imaging device of claim 6, wherein one color indicates a still photography mode of the camera and another color indicates a video mode of the camera.

10. The imaging device of claim 1, wherein the projection viewfinder assembly also projects a graphic or text component.

11. The imaging device of claim 10, wherein the graphic or text component is projected in the field of view of the camera to form part of a photograph taken with the camera or a video filmed with the camera.

12. The imaging device of claim 1, wherein the projected viewfinder includes projected spots that have a relationship with corners of the field of view of the camera.

13. The imaging device of claim 1, wherein the projected viewfinder includes projected lines that have a relationship with edges of the field of view of the camera.

14. The imaging device of claim 1, wherein the projected viewfinder is viewable with the naked eye of a user of the imaging device.

15. The imaging device of claim 1, wherein the projected viewfinder is not viewable with the naked eye of an observer of the field of view of the camera.

16. The imaging device of claim 1, wherein the imaging device is configured to communicate in a communications network and includes a radio circuit over which a call is established.

17. An imaging device, comprising:
a sensor for scanning a surface; and
a projection viewfinder assembly that projects a viewfinder to visually indicate a peripheral boundary of a field of view of the sensor.

18. A method of imaging a scene, comprising:
pointing a camera toward the scene;
projecting a viewfinder that visually indicates a field of view of the camera; and
imaging the scene with the camera.

19. The method of claim 18, wherein the imaging of the scene is one of taking a photograph or filming a video.

20. The method of claim 18, further comprising modifying the projected viewfinder in response to a change in zoom of the camera so that the projected viewfinder maintains a relationship with the field of view of the camera as the zoom of the camera changes.

21. The method of claim 18, further comprising changing a color of at least a portion of the projected viewfinder to indicate a condition related to the camera.
